(19) United States
(12) Patent Application Publication
(10) Pub. No.: US 2009/0327851 A1
(43) Pub. Date: Dec. 31, 2009

(54) Data analysis method

(76) Inventor: Steven Raposo, Neshanic Station, NJ (US)

Correspondence Address: GEARHART LAW, LLC, 4 FERNDALE ROAD, CHATHAM, NJ, 07928, US

(21) Appl. No.: 12/459,058

(22) Filed: Jun. 26, 2009

Related U.S. Application Data
(60) Provisional application No. 61/076,159, filed on Jun. 27, 2008.

(51) Int. Cl. G06F 17/00

(52) U.S. Cl. 715/213

(57) ABSTRACT

A data analysis method is disclosed. The method comprises aggregating related data tables with dissimilar data structures, and combining the tables, and data structures, into a single table that incorporates all the individual data structures. The single table is then analyzed via a pivot table function of a spreadsheet program, such as Microsoft Excel. The method is suited for quickly comparing related but dissimilar sets of data—an important task in virtually every field of human endeavor, from manufacturing to health care to financial services. The present invention provides an improved way to quickly access important strategic information using multiple sources of data.

### CLAIM OF PRIORITY

This application claims the priority of U.S. Ser. No. 61/076,159 filed on Jun. 27, 2008, the contents of which are fully incorporated herein by reference.

### FIELD OF THE INVENTION

The present invention relates to data analysis. More particularly, the present invention relates to an improved system and method for creating pivot tables.

### BACKGROUND

Pivot tables have been provided in numerous spreadsheet programs for several years. A pivot table provides an efficient way to display and summarize data that is included in a database or in the data listing of a spreadsheet by automatically displaying fields of the data in a manner determined by the user and by determining and displaying selected parameters such as the sum, variance, count, standard deviation, etc. of selected data fields. Relatively structured spreadsheets that already have subtotals, data entry cells, and summaries of fields are generally not appropriately expressed using a pivot table. In contrast, any data included in a database that can be queried from within the spreadsheet, or spreadsheet data comprising lists that are not already summarized are ideal candidates for the power of pivot tables.

The task of comparing standards to actual data (“actuals”) is common in many fields, including medicine, manufacturing, and project financial management. Data related to the reaction of test subjects to medicine or therapies must be compared to standards to determine if the medicine sufficiently treats the condition it was supposed to. In addition, actuals data pertaining to side effects must be compared to standards for allowable side effects, in order to determine if the side effects are not severe enough to outweigh the benefits of the medicine, and allow the medicine to be sold to the public.

In manufacturing, each manufactured unit has a specification that indicates the desired attributes of the unit (physical dimensions, physical qualities—hardness, softness, springiness, electrical quantities, performance qualities, etc. . . ). The manufactured units must be sampled, and the actual attributes measured, and the actual attributes compared to the specifications.

In project financial management, the actual costs and revenue incurred on a project must be compared to the budgets, schedules and forecasts for the project.

In standards vs. actuals analysis, by definition, the standards and actuals are related but dissimilar data. Some attributes may be shared or not shared. There may be a hierarchical parent-child relationship, or there may not be. A very powerful and flexible analysis and reporting tool is needed to compare standards to actuals. In addition, this analysis and reporting tool must be able to analyzed very large amounts of related, but dissimilar data. The additional ability to present graphical representations of the analysis and reporting would be of extreme usefulness.

Although pivot tables are a very powerful tool for processing and displaying data, they are best suited for accessing data that is in a single table format. Pivot tables can access “multiple consolidation ranges”, but the ranges are not actually separate, dissimilar tables.

The “single table” data management approach is discussed in U.S. Pat. No. 6,754,666, for use in hierarchical data tables. However, there the “single table approach” was disclosed for use with hierarchical data tables and not disparate data tables as taught in the present invention. Moreover, the '666 patent listed many disadvantages for the “single table” approach. These disadvantages include:
1. Data tables that are very wide, and include a large number of fields,
2. The existence of a lot of wasted space, because the records will be for one of the data sets only, and the schema, or table structure of the single table, will include the fields for all the data sets.
3. Opportunity for errors in the data, because of the large amount of blank cells. It can be difficult to recognize if a cell is blank because it should be, or because the cell is in error. In addition, it may be difficult to determine if an occupied cell should be occupied or blank.
4. It is difficult to dynamically alter the structure of the database once it is populated with data.

Therefore, it is desirable to have an improved system and method for analyzing data via pivot tables that overcomes the aforementioned limitations.

### SUMMARY OF THE INVENTION

The present invention provides an improved method for analyzing data with a pivot table. In particular, the present invention provides a single table approach that does not rely on any relationships between the tables, so the relationships between the tables can be ignored (for data management purposes), and attention can be placed on analyzing the data only. In particular, the present invention provides a method of combining related but dissimilar data into a single table in order for the data to be accessed by a pivot table.

### BRIEF DESCRIPTION OF THE DRAWINGS

FIGS. 1-4 illustrate an exemplary prior art pivot table process.

FIG. 5 is a flowchart indicating process steps for performing the method of the present invention.

FIG. 6 illustrates an exemplary source table.

FIG. 7 illustrates an exemplary additional source table.

FIG. 8 illustrates a single table that combines the tables of FIG. 6 and FIG. 7

FIG. 9A is an exemplary pivot table 900 illustrating an analysis of actuals data.

FIG. 9B is an exemplary pivot table illustrating a standards-actuals comparison.

FIG. 10 is an exemplary pivot table illustrating a project management analysis.

### DETAILED DESCRIPTION

To provide a context for the present invention, the basic fundamentals of a pivot table will be briefly explained.

The invention is a method comprising the steps of creating a single data table from at least two disparate data sets; activating a pivot table function, choosing at least two fields for a pivot table field list and using at least two fields from the pivot table field list to create a pivot table report.

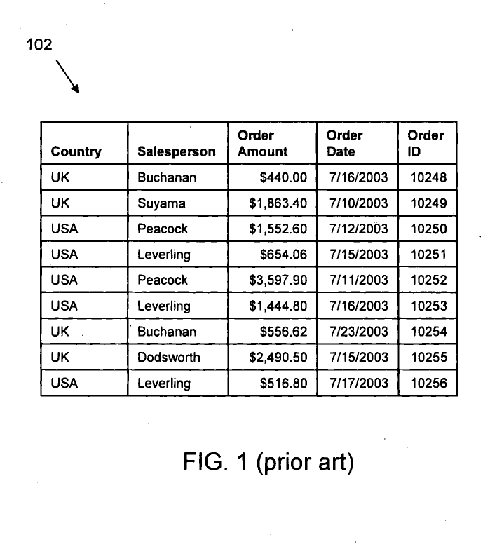

FIGS. 1-4 show the basic steps of creating a pivot table. In FIG. 1, a portion of the source data is shown in spreadsheet 102. The data comprises five columns. Each column represents a different field (e.g. country, salesperson, etc. . . ). Each row represents a tuple of values for the five field set. For example, row 5 represents the tuple <USA, Leverling, 654.06, Jul. 15, 2003, 10251>.

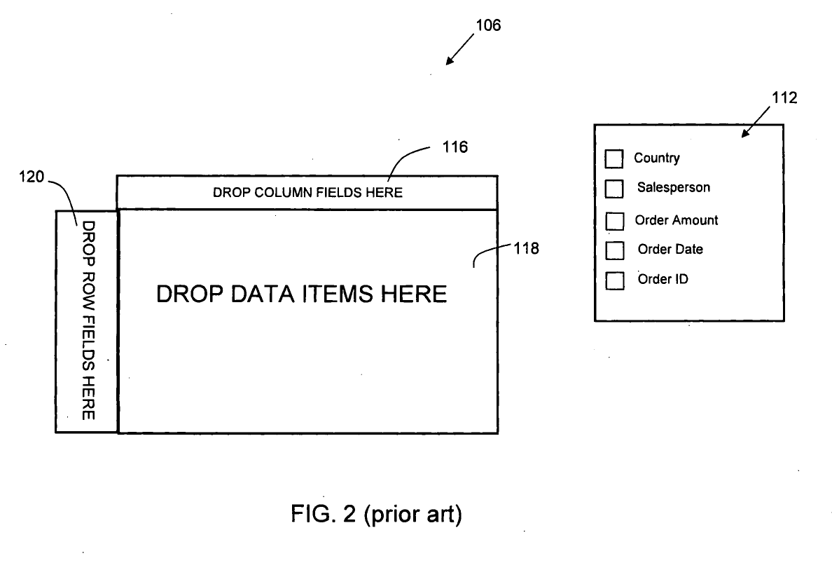

FIG. 2 shows the pivot table wizard 106 similar to that of MICROSOFT EXCEL. Other spreadsheet programs may have a similar wizard feature. In the wizard, the five fields are shown in the pivot table field list 112. These fields can be dragged to column region 116, data region 118 or row region 120 on the pivot table.

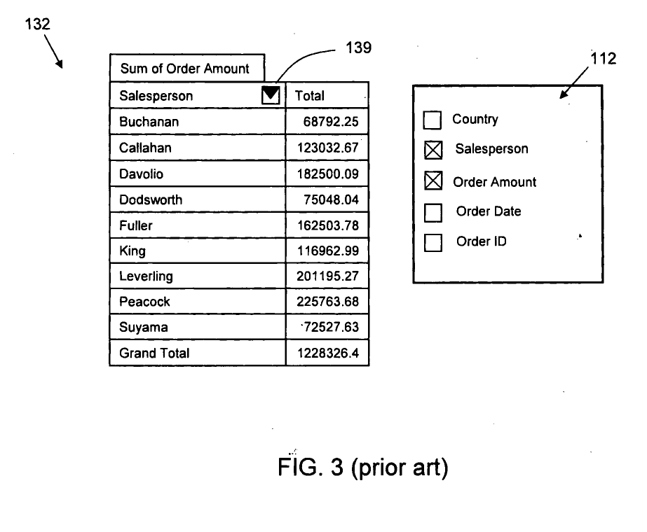

FIG. 3 shows an exemplary pivot table 132. To form this table, the salesperson field was dragged from the pivot table field list to the row area, and the order amount was dragged from the pivot table field list to the data area.

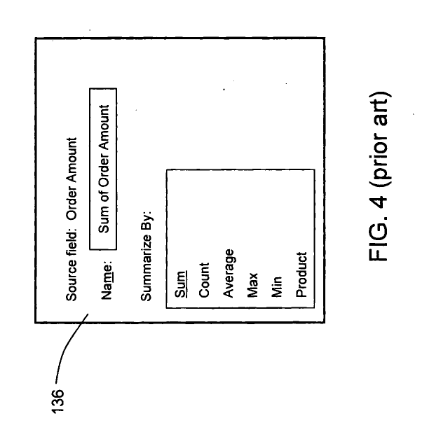

FIG. 4 shows some of the various options 136 provided by the pivot table. These options include features such as sum, count, average, maximum, minimum, and product, just to name a few. This is part of what makes pivot tables useful, as a variety of mathematical functions can be quickly applied to the desired data. When drop-down control 139 is selected, it provides the user a means to control which data items are displayed in pivot table 132. For example, the user can elect to show only a particular salesperson or subset of salespeople shown in table 132 (FIG. 3). In subsequent features of this disclosure, drop-down controls are referred to at various instances. However, for the sake of clarity in the drawings, additional drop-down controls are not indicated with a reference number, but are easily recognizable by the “upside down triangle” with a box.

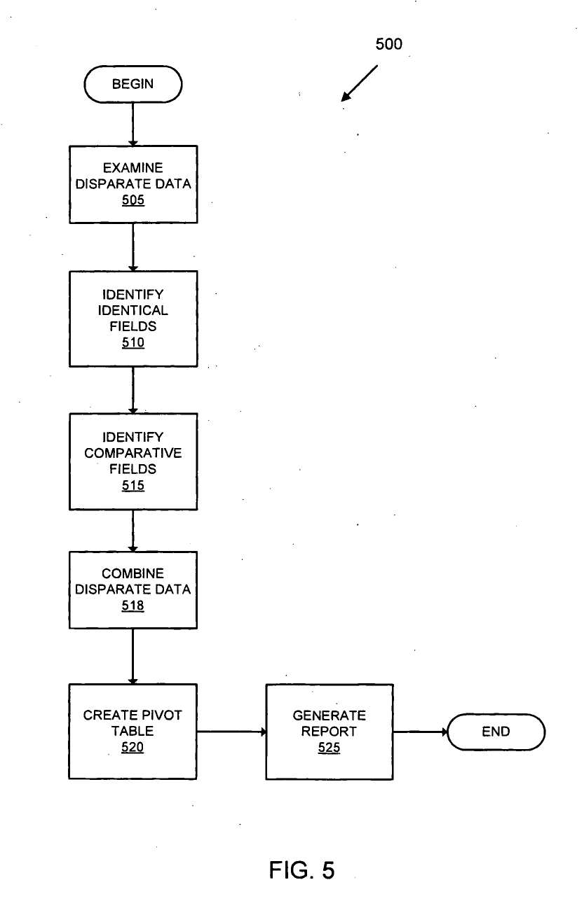

FIG. 5 illustrates a flowchart 500 indicated process steps to perform the method of the present invention. In process step 505, disparate data is examined. For the purposes of this disclosure, disparate data means that, among a plurality of data tables having a plurality of data fields, not all data fields are common across the plurality of data tables.

In process step 510, identical fields are identified. These fields can be used as a basis for comparison in standards-actuals analysis. For example, a “part number” field may exist in a standards table that indicates design specifications for a part number, and may also exist in an actuals table that indicates measured dimensions of parts that have been produced.

In step 515, comparative fields are identified. These are fields that are not common amongst the source tables that are forming the combined data, but have some semantic relationship. For example, in a standards table, a “design length” field may indicate the desired length of a part, whereas in an actuals table, a “measured length” field may indicate the actual length of a manufactured part. For standards-actuals analysis, it is desired to compare these fields, even though they are non-identical fields.

In step 518, disparate data is combined. Identical fields are combined into single fields. Comparative fields remain separate fields.

In step 520, a pivot table is created by activating a pivot table function. This may be performed via a “Wizard” application, such as that illustrated in FIGS. 1-4. The creation of pivot tables via this method is well known in the field of spreadsheets.

In step 525 at least two fields are selected to create a pivot table report that shows the desired data. The pivot table options (136 of FIG. 4) can be selected to show the desired information, for example, average, or sum, to name a few.

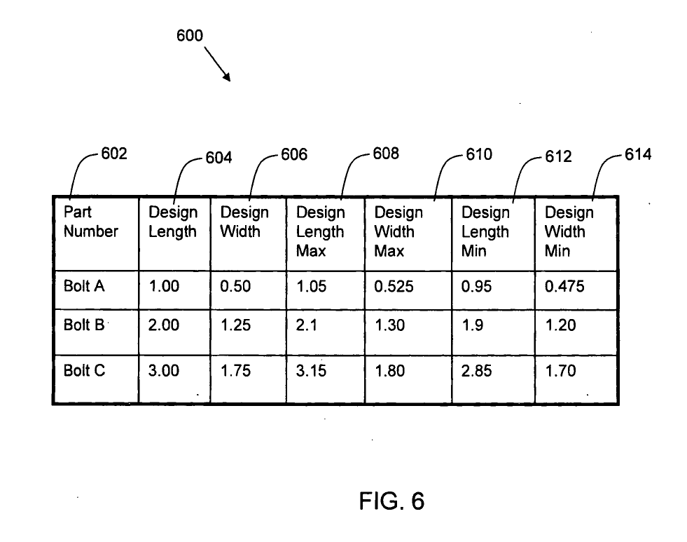

FIG. 6 illustrates an exemplary source table 600 that contains standards information. In this example, the standards information is design data for a plurality of different bolts. Column 602 indicates the part number for each bolt type. Column 604 indicates the target design length for each part. Column 606 indicates the target design width for each part. Column 608 indicates the maximum design length. If a manufactured part exceeds the maximum design length then it is “out of specification” and rejected. Column 610 indicates the maximum design width. If a manufactured part exceeds the maximum design width then it is “out of specification” and rejected. Column 612 indicates the minimum design length. If a manufactured part is less than the minimum design length then it is “out of specification” and rejected. Column 614 indicates the minimum design width. If a manufactured part is less than the minimum design width then it is “out of specification” and rejected.

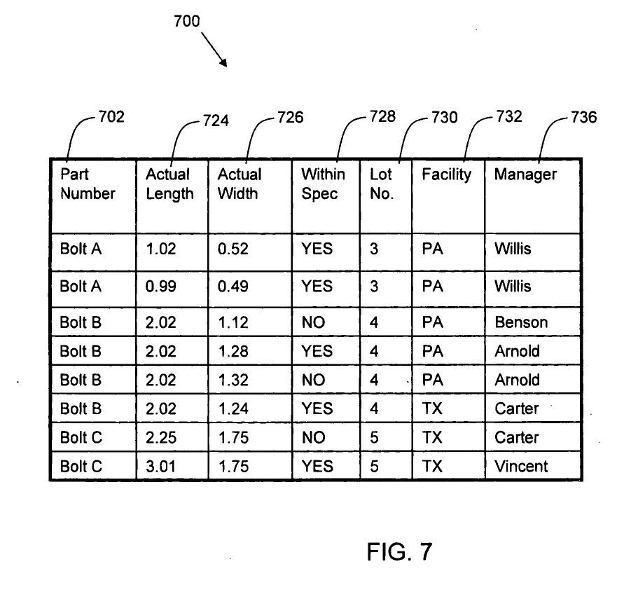

FIG. 7 indicates an exemplary additional source table 700 that contains actuals information for the parts indicated in FIG. 6. Column 702 indicates the part number for each bolt. Column 724 is the actual length of a manufactured bolt. Column 726 is the actual width of a manufactured bolt. Column 728 is an indication of if the manufactured bolt is within the design specification limits. Column 730 is a manufacturing lot number. Column 732 indicates a particular production facility. Column 736 indicates a production manager.

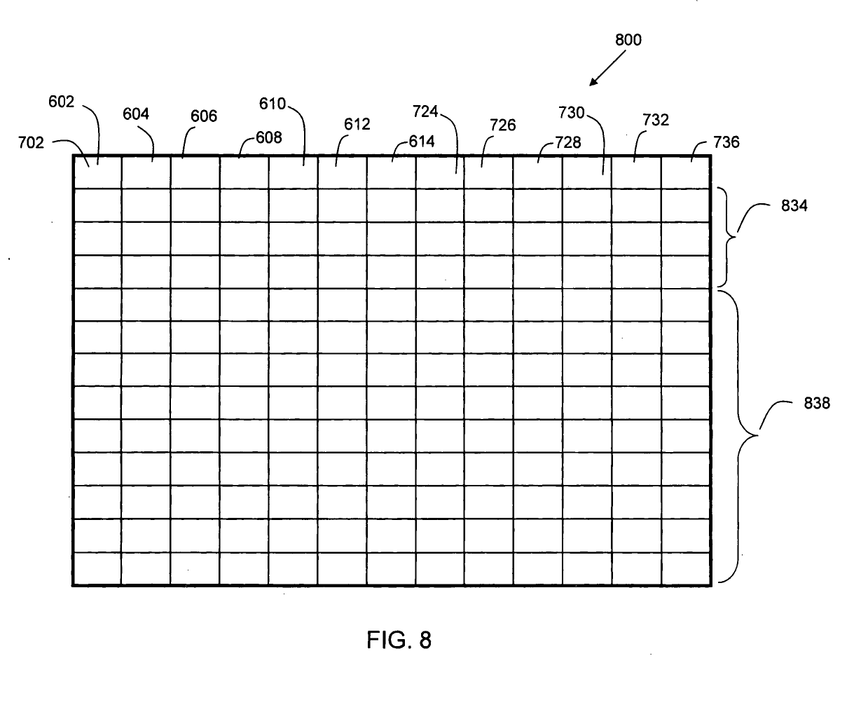

FIG. 8 indicates a single data table 800 that combines the data of the tables of FIG. 6 and FIG. 7. Therefore, single data table 800 contains data relating to both manufacturing standards as well as data relating to items actually manufactured. Note that, due to the size of the table, the data values are not indicated. However, the column reference numbers refer to those in FIG. 6 and FIG. 7. Columns 602 and 702 both refer to the leftmost column of table 800. In this case, columns 602 and 702 represent “identical fields.” That is, the “part number” field is present in both table 600 and table 700, and represents the identical information for both source tables, and therefore is consolidated in the single data table. The other columns (604, 606, 608, 610, 612, 614, 724, 726, 728, 730, 732, and 736) represent respectively indicated columns from FIG. 6 and FIG. 7. The group of rows indicated by 834 contains data from table 600. The group of rows indicated by 838 contains data from table 700. Note that while for illustration purposes, only a small number for rows are shown, in practice, group of rows 834 and 838 may be populated with hundreds (for example, a single data table populated with 250 data values), or even thousands of data values—limited only by the capability of the spreadsheet program. It is important to note that tables populated with more than 250 data values begin to exceed the limits of human recognition and consequently create a need for the present invention. Thus, while the pivot table approach may be useful for tables having 250 data values or more, the pivot table method disclosed herein may be useful for larger tables populated with 2,500, 250,000 or 250 million values. In addition, the present invention is suitable for use with disparate data tables having from 1 to 100 columns, and from 1 to 1 million rows.

Also note that the source tables 600 and 700 that are combined in single data table 800 may themselves be spreadsheet tables, but can also be tables residing in a database that is accessible by the spreadsheet program.

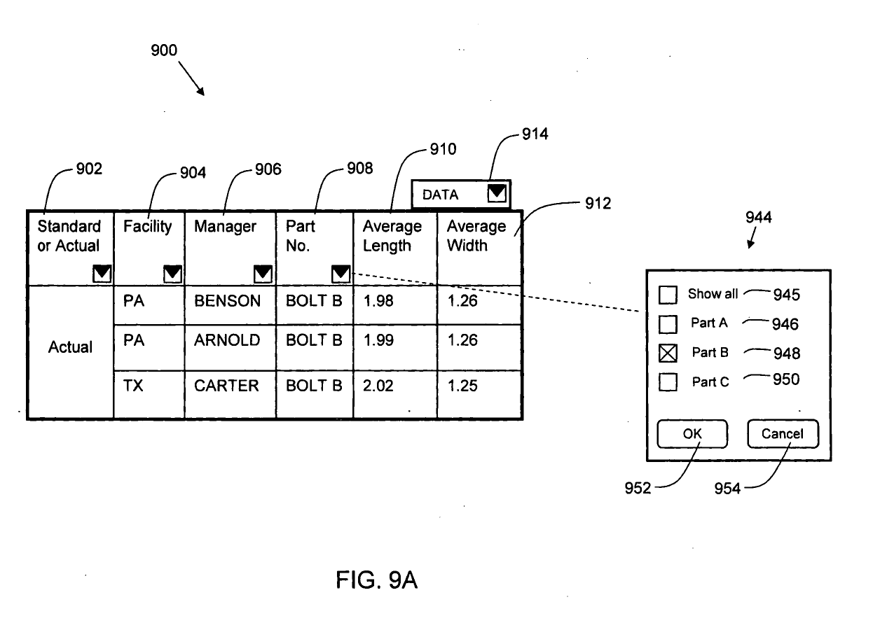

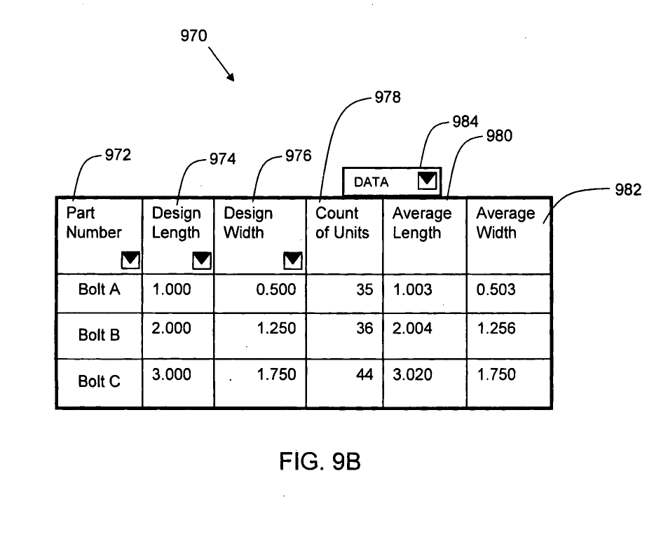

FIG. 9A is an exemplary pivot table 900 illustrating analysis of actuals data. Column 902 represents the indication of standards or actuals data. In this case, the actuals data is selected. Column 904 indicates the production facility. Column 906 indicates the production manager. Column 908 represents the part number. Column 910 shows the average actual length of a particular part (bolt B) by facility and production manager. Column 912 shows the average actual width of a particular part (bolt B) by facility and production manager. Drop-down control 914 allows a user to enable only column 910, only column 912, or both columns, as is illustrated here. The user can view a variety of data for analysis. For example, if the user selects the drop-down control of column 908, data selection box 944 corresponding to the part number field is displayed. Data selection box 944 has show all checkbox 945, part A checkbox 946, part B checkbox 948, and part C checkbox 950. OK button 952 accepts the options, and Cancel button 954 aborts the operation. In FIG. 9A, the part B checkbox 948 is the only one selected, and hence, only part B is shown in column 908.

This technique provides valuable information to a stakeholder in a manufacturing operation. The following list shows just a few examples of such information, other types of information are possible, and within the scope of the present invention.
Indicate trouble with a particular manufacturing facility
Indicate trouble with a particular production manager
Indicate trouble manufacturing a specific part

By using the appropriate data selection boxes, the data can be viewed by multiple criteria very quickly, providing important strategic information to a production manager, vice president of operations, or other important stakeholder.

FIG. 9B is an exemplary pivot table 970 illustrating a standards-actuals comparison. Column 972 represents the part number. Column 974 shows the design (ideal) length for each part. Column 976 shows the design (ideal) width for each part. Columns 974 and 976 represent standards data. Column 978 indicates the count of units that were examined. Column 980 and 982 show the average length and width, respectively, of the manufactured parts. Columns 980 and 982 represent actuals data. Hence, by comparing values in column 974 to values in column 980, and comparing values in column 976 to values in column 982, one can quickly compare the standards data to the actuals data, providing useful information for the manufacturing process. Drop-down control 984 allows a user to enable various columns (978, 980, 982) for display. The reader will recognize that the technique shown here can be applied to many other fields besides manufacturing.

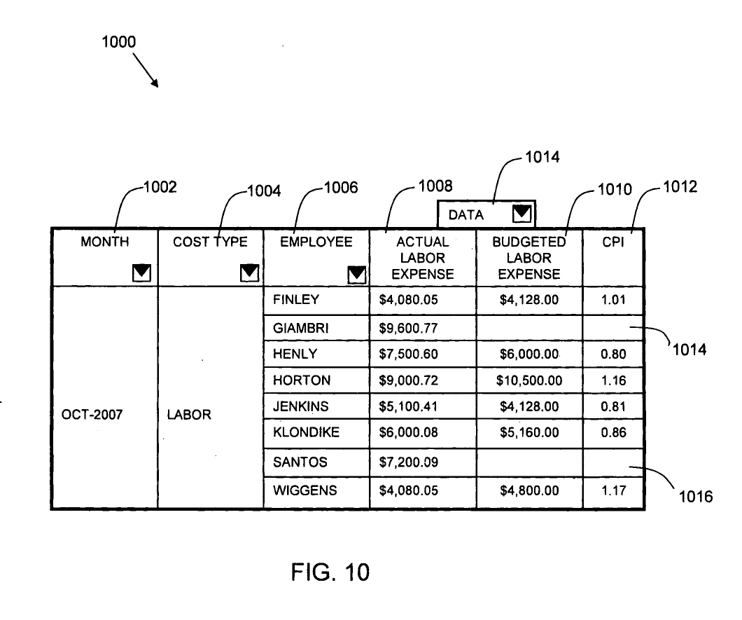

FIG. 10 is an exemplary pivot table 1000 illustrating a project management budget analysis. Column 1002 indicates a desired calendar month. Column 1004 indicates a desired cost type. Column 1006 indicates an employee. Column 1008 indicates an actual labor expense for the month indicated in column 1002. Column 1010 indicates a budgeted labor expense for the month indicated in column 1002. Column 1012 indicates a CPI (Cost Performance Index), which is the ratio of budgeted costs to actual costs. Ideally, the CPI should be greater than or equal to one. Column 1012 allows a user to see at a glance that some employees are over budget (when the CPI is less than 1) and some are under budget (where the CPI is greater than 1). However, an additional powerful advantage of this technique is that rows 1014 and 1016 are easily identified has having “missing information.” In particular, the “missing information” is the budgeted data for the employees corresponding to rows 1014 and 1016 (Giambri and Santos, respectively). This quickly highlights that two employees are working on a project for which they were not budgeted. This is only an example of the “missing information” technique, as there are many other applications where the absence of data can highlight an issue warranting further attention or investigation. This technique of identifying one or more rows of the pivot table wherein one or more data values are missing, serves as an error checking routine to identify these errors as early as possible, to minimize their adverse impact to a project.

### Disadvantages Avoided

Many disadvantages have been sited for the “single table” approach. Now that the present invention has been explained in detail, the aforementioned disadvantages to the “single table” approach are restated, followed by a summary of how the present invention overcomes these disadvantages:

1. Disadvantage—Data tables that are very wide, and include a large number of fields.
Solution—With modern computer technology, the problems presented by very large data tables are minimized, because of the massive computing power and graphical interface capabilities of modem systems. Thus for example, large scale pivot tables were impractical for PC processors in the 1990's which had limited capabilities to process data efficiently enough to utilize the pivot table approach disclosed herein.

2. The existence of a lot of wasted space, because each record will be for one of the data sets only, and the schema, or table structure of the single table, will include the fields for all the data sets. For each record, the fields that do not pertain to that record's data will be empty.
Solution—Again, modern computer technology nullifies the problems presented by processing large amounts of data.

3. Opportunity for errors in the data, because of the large amount of blank cells. It can be difficult to recognize if a cell is blank because it should be, or because the cell is in error. In addition, it may be difficult to determine if an occupied cell should be occupied or blank.
Solution—The analytical capabilities of pivot tables allow for quick and easy error detection and error correction in the source data. Example—To check for cells that are occupied in error, bring up a pivot table for each data set, then bring up the fields for the other data sets, in summary. (ex. Set up a pivot table for budgets, then bring up the fields for everything but budgets.) Since the pivot tale is summarizing the data, only a single line has to be reviewed. If any data shows up, it is in error.

4. It is difficult to dynamically alter the structure of the database once it is populated with data.
Solution—If the data table is stored as a spreadsheet table, it is relatively easy to alter either the data or the structure of the data table. And considering that the latest version of Excel (Excel 2007) now has one million rows per spreadsheet, (from 65,000 in the earlier version) then the opportunity exists to keep the data in Excel and not store it in a data base. If the data is stored as a database table in a database system like Access or SQL Server, it is more difficult to alter the structure of the populated database. However, instead of dynamically altering the structure of the database, the alternate method of simply recreating the database with an altered structure is easier with pivot tables. Example—A pivot table can be set up that includes an individual total for each dissimilar data set. (It does not matter what the field is, as long as the total includes all the records for an individual data set). Double clicking a total brings the database structure and all the records for that data set into a spreadsheet. The structure of each data set can be altered (the same way) and the data sets can be combined again into a single database table in the original database system (Access, SQL Server, etc.)

Earlier versions of Excel utilized computer systems having far less capability than current computer systems. For example, the system requirements for Excel 97 were 486 or higher processor (486 processors operated at 33 to 100 MHz); 8 megabytes (MB) of RAM for use on Windows 95; 16 megabytes (MB) of RAM for use on Windows NT; 22-64 MB of hard drive space required; 36 MB required for typical installation.

In contrast, Excel 2007's system requirements are 500 MHz processor or higher; 256 megabytes (MB) of RAM or higher; 1.5 gigabytes (GB) of hard drive space; (a portion of this disk space will be freed after installation of the original downloaded package is removed from the hard drive).

The system requirements for the newest Excel version (Excel 2007) include a processor that is 5 to 15 times faster than the processor required for Excel 97. The RAM requirements for Excel 2007 are 16 to 32 times larger than the requirements for Excel 97. The required hard drive space for Excel 2007 is 23 to 68 times larger than the required hard drive space for Excel 97. The minimum system requirements reflect how system capabilities have changed and how more computing power makes possible larger data tables in Excel. It is expected that the data tables of the present invention will be run on systems or their equivalent of a minimum of 500 MHz processor or higher; 256 megabytes (MB) of RAM or higher; 1.5 gigabytes (GB) of hard drive space or greater. equivalent

Also, it is expected that new versions of Excel are the preferred platform to utilize the present invention. For example, Excel 97 to Excel 2003 are limited to approximately 64,000 rows and 256 columns. Excel 2007 has the capability to over 1 million rows and over 16,000 columns.

Excel 2007 has (1 million /64K=) 15 times the number of rows and (16,384/256=) 64 times the number of columns of Excel 97. The massive increase of the size of the Excel worksheets from the Excel 97 version to the current Excel 2007 version, and the massive increase in the system requirements for the Excel 2007 version over the Excel 97 version is indicative of the increase in computing and data handling power of modem personal computer systems that makes many of the drawbacks of the single table approach irrelevant.

The present invention provides powerful methods for data analysis. They provide a means to quickly analyze, and extract key information from large sets of data. This allows important operational decisions to be made quickly. The methods of the present invention can be applied to a variety of application, including, but not limited to, business, manufacturing, project management, engineering, medicine, and logistics, just to name a few.

It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

What is claimed is:

1. A method, comprising the steps of:
creating a single data table from at least two disparate data sets;
activating a pivot table function;
choosing at least two fields for a pivot table field list; and
using at least two fields from the pivot table field list to create a pivot table report.

2. The method of claim 1, wherein the single data table is created in Microsoft Excel.

3. The method of claim 1, wherein the single data table is created from data residing in a database.

4. The method of claim 1, wherein an error checking routine checks the single data table.

5. The method of claim 4, wherein the error checking routine comprises the steps of identifying one or more rows of the pivot table report wherein one or more data values are missing.

6. The method of claim 1, wherein at least one data set has data relating to manufacturing standards and another data set has data relating to items actually manufactured.

7. The method of claim 1, wherein at least one data set has a field relating to calendar months.

8. The method of claim 1, wherein at least one data set has data relating to a budget, and another data set has data relating to actuals.

9. The method of claim 1, wherein the single data table is populated with at least two hundred data values.

10. A pivot table report created according to the method of claim 1.

11. A method, comprising the steps of:
creating a single data table populated with 250 data values;
activating a pivot table function;
choosing at least two fields for a pivot table field list; and
using at least two fields from the pivot table field list to create a pivot table report.

12. The method of claim 11, wherein the single data table is created in Microsoft Excel.

13. The method of claim 11, wherein the single data table is created from data residing in a database.

14. The method of claim 11, wherein an error checking routine checks the single data table.

15. The method of claim 14, wherein the error checking routine comprises the steps of identifying one or more rows of the pivot table report wherein one or more data values are missing.

16. The method of claim 11, wherein at least one data set has data relating to manufacturing standards and another data set has data relating to items actually manufactured.

17. The method of claim 11, wherein at least one data set has a field relating to calendar months.

18. The method of claim 11, wherein at least one data set has data relating to a budget, and another data set has data relating to actuals.

19. A pivot table report created according to the method of claim 11.
